(19) United States
(12) Patent Application Publication
(10) Pub. No.: US 2016/0280230 A1
(43) Pub. Date: Sep. 29, 2016

(54) DETECTING METHOD AND DETECTING SYSTEM FOR PERFORMING A DRIVING SAFETY EVALUATION, AND AN IN-VEHICLE COMPUTER AND A WEARABLE DEVICE INCLUDED IN THE DETECTING SYSTEM

(71) Applicant: Mitac International Corp., Taoyuan City (TW)

(72) Inventor: Feng-Ming Hsieh, Taoyuan City (TW)

(21) Appl. No.: 15/080,178

(22) Filed: Mar. 24, 2016

(30) Foreign Application Priority Data
Mar. 26, 2015 (TW) 104109806

(51) Int. Cl. B60W 40/08; B60Q 9/00; B60K 28/06

(52) U.S. Cl. CPC B60W 40/08; B60K 28/06; B60Q 9/00; B60W 2040/0872; B60W 2040/0818; B60W 2040/0836; B60W 2040/0827

(57) ABSTRACT

In a detecting method for performing driving safety evaluation regarding a state of a driver of a vehicle, a detecting system: collects physiological data of the driver; performs the driving safety evaluation based on the physiological data to determine whether the state of the driver is unsuitable for operating the vehicle; and when it is determined that the state of the driver is unsuitable for operating the vehicle, triggering an interference action that includes one of outputting an alert, preventing the vehicle from starting up and a combination thereof.

### CROSS-REFERENCE TO RELATED APPLICATION

This application claims priority of Taiwanese Application No. 104109806, filed on Mar. 26, 2015.

### FIELD

The disclosure relates to a detecting method and a detecting system for performing a driving safety evaluation for a driver, and an in-vehicle computer and a wearable device included in the detecting system.

### BACKGROUND

An in-vehicle computer (also known as a car personal computer) built in a vehicle may be designed to assist. a driver for safe driving. For example, the in-vehicle computer may cooperate with a camera that captures the face of the driver while he/she is operating the vehicle in order to determine whether the driver is in a state of drowsy driving.

### SUMMARY

An object of the disclosure is to provide a detecting method that can perform a driving safety evaluation regarding a state of a driver of a vehicle.

According to the disclosure, the detecting method is to be implemented by a detecting system, and includes the steps of:

collecting physiological data of the driver;

performing a driving safety evaluation based on the physiological data to determine whether the state of the driver is unsuitable for driving; and

when it is determined that the state of the driver is unsuitable for driving, triggering an interference action that includes one of outputting an alert, preventing the vehicle from starting up and a combination thereof.

In embodiments of the disclosure, the detecting method may be executed before the driver operates a vehicle.

Another object of the disclosure is to provide a detecting system that is configured to execute the aforementioned method.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating a detecting system according to one embodiment of the disclosure;

FIG. 2 is a flow chart illustrating steps of a method for performing driving safety evaluation to be implemented by the detecting system according to one embodiment of the disclosure; and

FIG. 3 is another flowchart illustrating steps of a method for performing driving safety evaluation to be implemented by the detecting system according to one embodiment of the disclosure.

### DETAILED DESCRIPTION

Before the disclosure is described in greater detail, it should be noted that like elements are denoted by the same reference numerals throughout the disclosure.

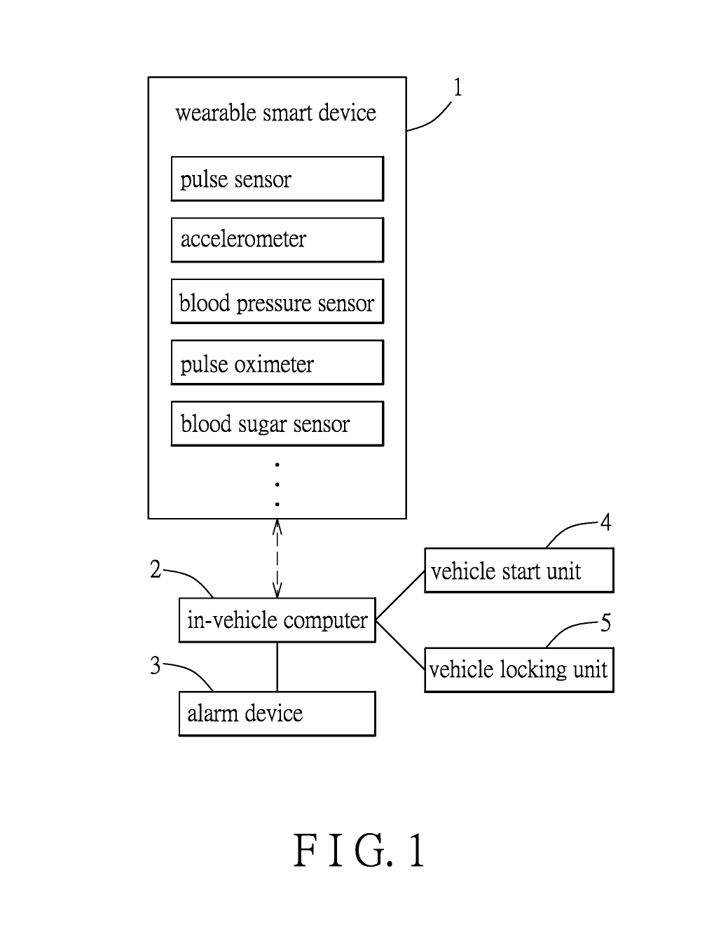

FIG. 1 is a block diagram illustrating a detecting system according to one embodiment of the disclosure. The detecting system is for performing driving safety evaluation regarding a state of a driver (not shown) of a vehicle (not shown) , and includes an in-vehicle computer 2 and a wearable smart device 1 that is to be worn by the driver.

The wearable smart device 1 may be embodied using a smart wristband, a smart watch, etc. The wearable smart device 1 is capable of communicating with the in-vehicle computer 2 using a short-range wireless communication protocol such as Bluetooth®, near field communication (NFC) etc.

The wearable smart device 1 includes components for measuring physiological data of the driver, such as a pulse sensor, an accelerometer, a blood pressure sensor, a pulse oximeter, a blood sugar sensor, etc.

In this embodiment, the in-vehicle computer 2 is coupled to an alarm device 3, a vehicle start unit 4 and a vehicle locking unit 5. The alarm device 3 may be built in the vehicle. The vehicle start unit 4 controls the start (i.e., ignition) of the vehicle. The vehicle locking unit 5 controls a plurality of door locks of the vehicle.

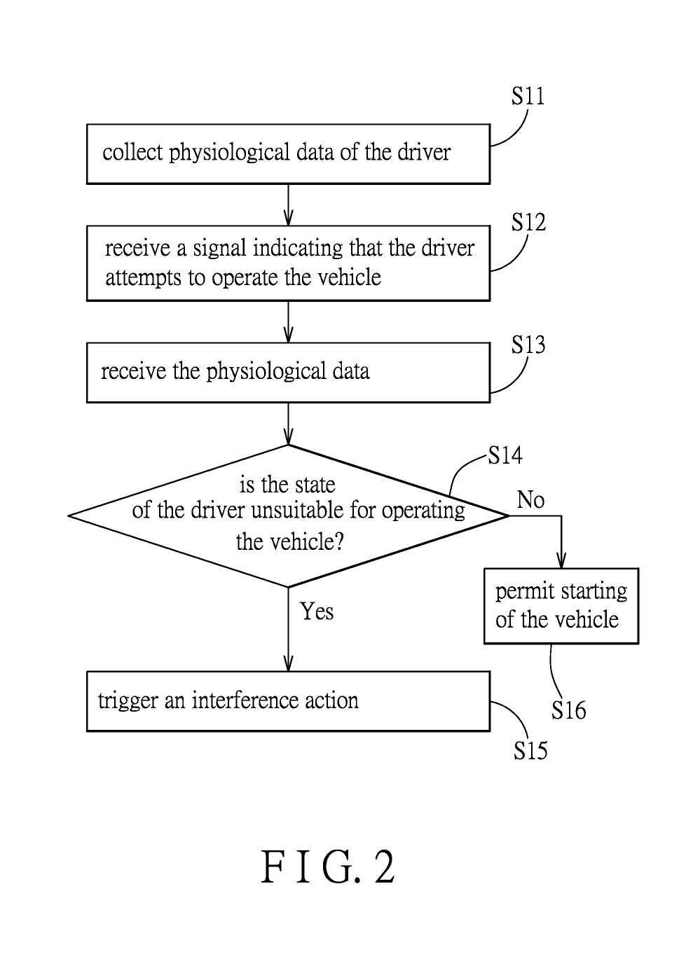

FIG. 2 is a flow chart illustrating steps of a method for performing driving safety evaluation to be implemented by the detecting system according to one embodiment of the disclosure.

In step S11, the wearable smart device 1, which is worn by the driver, regularly (continuously, periodically, etc.) collects physiological data of the driver.

Specifically, the wearable smart device 1 measures and records a blood pressure of the driver, a pulse of the driver, an amount of exercise (measured using the accelerometer) and a blood content (e.g., a blood sugar, an oxygen saturation) of the driver as the physiological data.

In step S12, before the driver operates the vehicle, the in-vehicle computer 2 receives a signal indicating that the driver attempts to operate the vehicle. Specifically, this may be done in a number of ways.

For example, the driver may approach the vehicle, and when the wearable smart device 1 is brought by the driver into vicinity of the in-vehicle computer 2, the wearable smart device 1 may transmit the signal to the in-vehicle computer 2, allowing the wearable smart device 1 to connect to the in-vehicle computer 2. Alternatively, the driver may manually operate the wearable smart device 1 to send out a signal to the in-vehicle computer 2 in order to establish a connection to the in-vehicle computer 2.

In another example, the driver may transmit an unlock signal to the in-vehicle computer 2 in an attempt. to unlock a door (not shown) of the vehicle (e.g., the door next to a driver's seat (riot shown)) by, for example, inserting a key (not shown) to a lock (not shown) on the door, pressing an unlock button (not shown) of a remote controller (not shown), or operating the wearable smart device 1 to transmit the unlock signal to the the in-vehicle computer 2.

In another example, the driver may transmit a start signal to the in-vehicle computer 2 in an attempt to start the vehicle by, for example, manually pressing a start button (not shown) of the vehicle, or operating the wearable smart device 1 to transmit the start signal to the in-vehicle computer 2.

In any one of the cases, the in-vehicle computer 2 is notified that the driver attempts to operate the vehicle, and establishes a connection with the wearable smart device 1.

Afterward, in step S13, the in-vehicle computer 2 receives the physiological data from the wearable smart device 1 for further processing. In practice, the in-vehicle computer 2 may instruct the driver to place the wearable smart device 1 in vicinity of a data transmission zone (not shown) disposed in the vehicle. When the wearable smart device 1 is placed near the data transmission zone, the physiological data can be transmitted to the in-vehicle computer 2. In another example, the data transmission zone is disposed on a doorknob (not shown) of the door next to the driver's seat, and as the driver reaches for the doorknob, the physiological data can be transmitted to the in-vehicle computer 2 automatically, should the wearable smart device 1 be worn on/near the driver's wrist. The physiological data transmitted is those most recently collected over an evaluation period (e.g., the previous 24 hours).

It is noted herein that in the case that the in-vehicle computer 2 receives the unlock signal, step S13 may be performed after the in-vehicle computer 2 controls the vehicle locking unit 5 to unlock the door of the vehicle.

It should be noted that the transmission of the physiological data may be triggered by a mechanism other than those illustrated in steps S12 and S13 herein, as long as it is before the user starts the vehicle or as the user is starting the vehicle.

In step S14, the in-vehicle computer 2 performs driving safety evaluation based on the physiological data to determine whether the state of the driver is unsuitable for operating the vehicle.

Specifically, in the driving safety evaluation, the in-vehicle computer 2 determines that the state of the driver is unsuitable for driving the vehicle when the physiological data indicates that the driver is lack of sleep, has consumed alcohol or is driving under the influence (DUI) of alcohol.

The in-vehicle computer 2 is able to determine whether the driver was in a sleep state based on the pulse of the driver (e.g., below a threshold pulse) and the amount of exercise of the driver (e.g., being minimal for an extended period). The in-vehicle computer 2 determines that the driver lacks sleep when the driver was in the sleep state for shorter than a predetermined threshold value (such as five hours) within the evaluation period.

The in-vehicle computer 2 is able to determine that the driver has consumed alcoholic beverages when the blood pressure of the driver and the pulse of the driver increase, and/or when the blood content of the driver indicates a blood alcohol concentration higher than a predetermined threshold value.

The in-vehicle computer 2 then determines whether the state of the driver is suitable or not for driving based on the above determinations. When it is determined that the state of the driver is suitable, the flow proceeds to step S16. Otherwise (i.e., the driver is deemed to be unsuitable for driving the vehicle), the flow proceeds to step S15.

In step S15, the in-vehicle computer 2 triggers an interference action. The interference action may include outputting an alert to notify the driver that he/she is not in a state suitable for driving.

In some more serious cases (e.g., it is determined that the driver is currently in an intoxicated state and/or has not been in the sleep state for the past 24 hours), the interference action may include preventing the vehicle from starting up. It is noted that in the case that the driving safety evaluation is performed after the start signal is received, the in-vehicle computer 2 does not start the vehicle outright.

Specifically, the in-vehicle computer 2 may instruct, the driver to perform a specific action (e.g., input a randomly generated string or a preset pin) in order to start the vehicle. Alternatively, the in-vehicle computer 2 may forcibly prohibit the vehicle from starting up (i.e., all means for starting the vehicle may be disabled).

In step S16, the in-vehicle computer 2 permits starting of the vehicle. In the case that the driving safety evaluation is performed after the unlock signal is received, the in-vehicle computer 2 does not perform operation associated with the vehicle start unit 4, but simply allows for such operation to be subsequently performed. In the case that the driving safety evaluation is performed after the start signal is received, the in-vehicle computer 2 controls the vehicle start unit 4 to start the vehicle.

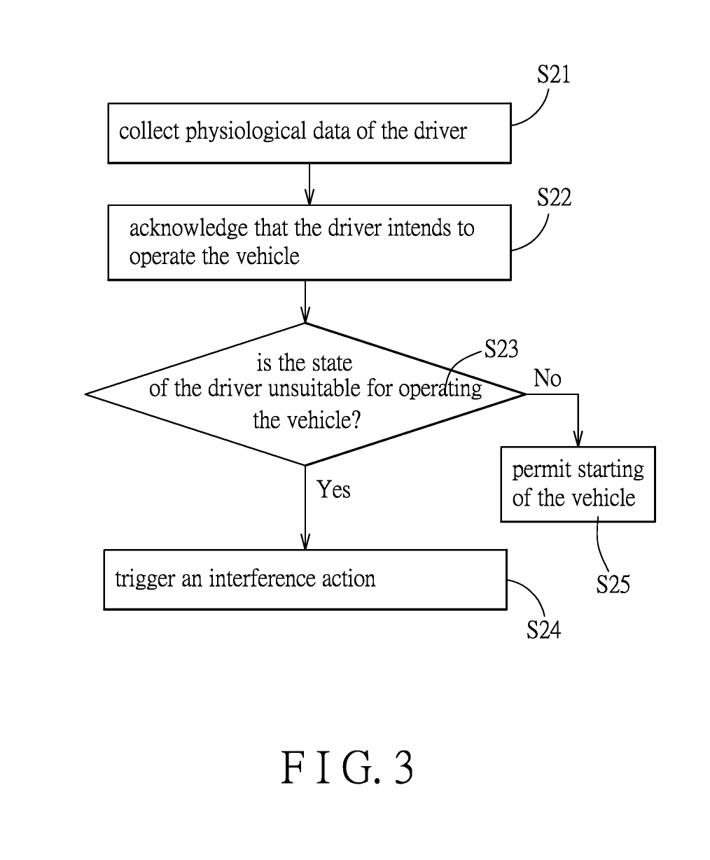

FIG. 3 is a flowchart illustrating steps of a method for performing a driving safety evaluation to be implemented by the detecting system according to one embodiment of the disclosure.

Step S21 is similar to S11 of FIG. 2, where the wearable smart device 1, which is worn by the driver, collects physiological data of the driver.

In step S22, the wearable smart device 1 acknowledges that the driver intends to operate the vehicle, and prepares to perform the safety evaluation. In this embodiment, the wearable smart device 1 may be able to acknowledge in-vehicle computer 2 that the driver intends to operate the vehicle in a number of ways. For example, the driver may wear the wearable smart device 1 and place it in the vicinity of a near-distance communication zone (not shown) of the vehicle that is connected to the in-vehicle computer 2, and subsequent attempts to connect to the in-vehicle computer 2 and a response from the in-vehicle computer 2 notifies the wearable smart device 1 that the driver intends to operate the vehicle. Alternatively, the driver may manually operate the wearable smart device 1 so as to notify the wearable smart device 1 to perform the safety evaluation.

Afterward, in step S23, the wearable smart device 1 performs the driving safety evaluation based on the physiological data to determine whether the state of the driver is unsuitable for operating the vehicle. When it is determined that the state of the driver is suitable, the flow proceeds to step S25. Otherwise (the driver is deemed to be unsuitable to drive the vehicle) the flow proceeds to step S24.

In step S24, the wearable smart device 1 triggers an interference action. The interference action may include outputting an alert to notify the driver that he/she is not in a state suitable for driving, and/or preventing the vehicle from starting up.

In the case of preventing the vehicle from starting up the wearable smart device 1 may notify the in-vehicle computer 2 to instruct the driver to perform. a specific action in order to start the vehicle. Alternatively, the wearable smart device 1 may notify the in-vehicle computer 2 to prohibit the vehicle from starting up. In this case, attempting to operate the wearable smart device 1 to transmit the start signal to the in-vehicle computer 2 may be blocked.

In step 25, the wearable smart device 1 allows the vehicle to be started.

It is noted herein that the wearable smart device 1 may transmit, for example, the unlock signal to the in-vehicle computer 2 upon acknowledging the user's attempt to operate the vehicle during step S22 so as to control the vehicle locking unit 5 to unlock the door of the vehicle. Alternatively, the wearable smart device 1 may transmit the unlock signal to the in-vehicle computer during step S25.

To sum up, the method and detecting system as described in the embodiments of the disclosure provide a way to determine the state of the driver and to prevent the driver who is deemed unsuitable to operate the vehicle from even starting the vehicle.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A detecting method for performing driving safety evaluation regarding a state of a driver of a vehicle, the method to be implemented by a detecting system, and comprising the steps of:
collecting physiological data of the driver;
performing the driving safety evaluation based on the physiological data to determine whether the state of the driver is unsuitable for operating the vehicle; and
when it is determined that the state of the driver is unsuitable for operating the vehicle, triggering an interference action that includes one of outputting an alert, preventing the vehicle from starting up, and a combination thereof.

2. The method of claim 1, wherein in the driving safety evaluation, the detecting system determines that the state of the driver is unsuitable for driving the vehicle when the physiological data indicates that the driver is lack of sleep, has consumed alcohol or is driving under influence.

3. The method of claim 2, the detecting system including a wearable smart device that is configured to be worn by the driver, and an in-vehicle computer that. communicates with the wearable smart device,
wherein, in the step of collecting the physiological data, the wearable smart device measures and records a pulse of the driver and an amount of exercise of the driver as the physiological data of the driver, and transmits the physiological data to the in-vehicle computer,
wherein, in the driving safety evaluation, the in-vehicle computer determines whether the driver is in a sleep state based on the pulse of the driver and the amount of exercise of the driver, and determines that the driver is lack of sleep when the physiological data indicates that the driver was in the sleep state for shorter than a predetermined threshold length within an evaluation period.

4. The method of claim 2, the detecting system including a wearable smart device that is configured to be worn by the driver, and an in-vehicle computer that communicates with the wearable smart device,
wherein, in the step of collecting the physiological data, the wearable smart device measures and records a blood pressure of the driver, a pulse of the driver and a blood content of the driver as the physiological data, and transmits the physiological data to the in-vehicle computer,
wherein, in the driving safety evaluation, the in-vehicle computer determines that the driver has consumed alcohol or is driving under influence when the blood pressure of the driver and the pulse of the driver increase, and the blood content of the driver indicates the driver is driving under influence.

5. The method of claim 1, the detecting system including a wearable smart device that is configured to be worn by the driver, and an in-vehicle computer that communicates with the wearable smart device,
wherein, in the step of collecting the physiological data, the wearable smart device measures and records the physiological data, and the in-vehicle computer receives the physiological data from the wearable smart device after receiving one of an unlock signal to unlock a door of the vehicle and a start signal to start the vehicle.

6. The method of claim 5, wherein the one of the unlock signal and the start signal is transmitted by the wearable smart device.

7. The method of claim 1, the detecting system including a wearable smart device that is configured to be worn by the driver, and an in-vehicle computer that communicates with the wearable smart device,
wherein, in the step of collecting the physiological data, the wearable smart device measures and records the physiological data, and the in-vehicle computer receives the physiological data from the wearable smart device,
wherein the in-vehicle computer is programmed to perform the driving safety evaluation and the interference action.

8. The method of claim 7, wherein the in-vehicle computer and the wearable device are configured to communicate with each other using a near field communication (NFC) protocol.

9. The method of claim 7, wherein in preventing the vehicle from starting up, the in-vehicle computer instructs the driver to perform a specific action in order to start the vehicle.

10. The method of claim 7, wherein in preventing the vehicle from starting up, the in-vehicle computer prohibits the vehicle from starting up.

11. The method of claim 1, the detecting system including an in-vehicle computer programmed to communicate with a wearable smart device worn by the driver, the wearable smart device being configured to measure and record the physiological data,
wherein, in the step of collecting the physiological data, the in-vehicle computer receives the physiological data from the wearable smart device.

12. The method of claim 1, the detecting system including a wearable smart device configured to communicate with an in-vehicle computer, wherein:
in the step of collecting the physiological data, the wearable smart device measures and records the physiological data;
the wearable smart device is programmed to perform the driving safety evaluation, and
when it is determined by the wearable smart device that the state of the driver is unsuitable for operating the vehicle, trigger an interference action that includes one of outputting an alert, preventing the vehicle from starting up and a combination thereof and that is to be carried out by the in-vehicle computer.

13. The method of claim 12, wherein in preventing the vehicle from starting up, the wearable smart device controls the in-vehicle to perform one of the following operations:
instructing the driver to perform a specific action in order to start the vehicle; and
prohibiting the vehicle from starting up.

14. The method of claim 1, wherein said method is implemented before the driver operates the vehicle.

15. A detecting method for detecting a state of a driver before the driver operates a vehicle, the method to be implemented by a wearable smart device, and comprising the steps of:
collecting a plurality of physiological data of the driver before the driver operates the vehicle; and
transmitting the physiological data of the driver to an in-vehicle computer, so as to allow the in-vehicle computer to perform driving safety evaluation based on the physiological data to determine whether the state of the driver is unsuitable for operating the vehicle, and to trigger an interference action that includes one of outputting an alert, preventing the vehicle from starting up and a combination thereof when it is determined that the state of the driver is unsuitable for operating the vehicle.

16. A detecting system for performing driving safety evaluation regarding a state of a driver of a vehicle, said detecting system being programmed to execute a method of claim 1.

17. A detecting system for performing driving safety evaluation regarding a state of a driver of a vehicle, said detecting system comprising a wearable smart device that is configured to be worn by the driver, and an in-vehicle computer that communicates with the wearable smart device, said detecting system being programmed to execute a method of claim 7.

18. An in-vehicle computer programmed to communicate with a wearable smart device worn by a driver, said in-vehicle computer being programmed to execute a method of claim 11.

19. A wearable smart device configured to communicate with an in-vehicle computer, said wearable smart device being programmed to execute a method of claim 12.

20. A detecting method for performing driving safety evaluation regarding a state of a driver of a vehicle, the method to be implemented by a detecting system, and comprising the steps of:
collecting physiological data of the driver;
performing the driving safety evaluation based on the physiological data to determine whether the physiological data indicates that the driver is lack of sleep; and
when it is determined that the driver is lack of sleep, triggering an interference action that includes one of outputting an alert, preventing the vehicle from starting up, and a combination thereof.
